(19) United States
(12) Patent Application Publication
(10) Pub. No.: US 2004/0057764 A1
(43) Pub. Date: Mar. 25, 2004

(54) Electrophotographic printer having detector to detect OHP paper

(75) Inventor: Heung-kyu Jang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/393,987

(22) Filed: Mar. 24, 2003

(30) Foreign Application Priority Data
Sep. 24, 2002 (KR) 2002-57809

(51) Int. Cl. G03G 15/00

(52) U.S. Cl. 399/389

(57) ABSTRACT

An electrophotographic printer including at least one paper feeder, a printing unit, a feed roller, and an overhead projector paper detector. The at least one paper feeder loads recording media. The printing unit transfers a toner image formed according to an electrophotographic method to the recording media fed from the paper feeder and applies heat and pressure to the recording media so that the toner image is fixed and fused to the recording media. The feed roller is installed between paper feeder and the printing unit and advances the recording media fed from the paper feeder to the printing unit. The overhead projector paper detector is installed between the feed roller and the printing unit to determine whether the recording media are OHP papers. Accordingly, even though recording media are fed from a plurality of cassettes, only one OHP paper detector can detect OHP papers.

### CROSS-REFERENCE TO RELATED APPLICATIONS

This application claims the benefit of Korean Application No. 2002-57809, filed Sep. 24, 2002, in the Korean Intellectual Property Office, the disclosure of which is incorporated herein by reference.

### BACKGROUND OF THE INVENTION

1. Field of the Invention

The present invention relates to an electrophotographic printer, and more particularly, to an electrophotographic printer using a plain paper and an overhead projector paper (OHP) .

2. Description of the Related Art

In electrophotographic printers, an electrostatic latent image is formed by scanning light onto a photoreceptor medium charged with a uniform surface potential and then using a potential difference between a light-scanned portion and a light-not-scanned portion of the photoreceptor medium. Next, a developer is supplied to the electrostatic latent image to form a visible toner image, and then the visible toner image is transferred to a recording medium via a predetermined transfer medium. Here, the visible toner image is a temporary image, which sticks to the recording medium due to an electrostatic force and may be detached from the recording medium due to an external physical impact. Thus, a fixing unit applies heat and pressure to the visible toner image to fuse and fix the visible toner image to the recording medium. As a result, an image is completely printed.

The recording medium may generally include various types of media, such as plain paper, overhead projector (OHP) paper, and so forth. These recording media have different thermal characteristics. The fixing unit transmits high heat of more than 100° C. to the recording medium. In particular, since the OHP paper is sensitive to high heat, the OHP paper has to be treated differently from the plain paper in a fixing process.

FIG. 1 is a cross-sectional view of a conventional electrostatic printer. Referring to FIG. 1, the conventional electrostatic printer includes a charger 11, a laser scanning unit (LSU) 12, a developer unit 13, a transfer unit 14, and a fixing unit 15. The charger 11 charges the surface of a photoreceptor drum 10 with a uniform surface potential. The LSU 12 scans light onto the photoreceptor drum 10 to form an electrostatic latent image. The developer unit 13 feeds a developer to the electrostatic latent image to form a toner image. The transfer 14 transfers the toner image to recording media (paper) S. The fixing unit 15 fixes the toner image to the recording media S. The recording media S stacked in a paper cassette 20 are advanced one by one by a pickup roller 21. An optical path 23, through which light can pass, is formed in a loading plate 22 of the paper cassette 20. A light receiving unit 32 and a light emitting unit 31 are installed over and under the loading plate 22.

The plain paper does not transmit light well while the OHP paper as a transparent paper transmits light well. Thus, the intensity of light detected by the light receiving unit 32 when the plain papers are loaded on the loading plate 22 is different from the intensity of light detected by the light receiving unit 32 when the OHP papers are loaded on the loading plate 22. It is determined from this difference whether the recording media S loaded on the loading plate 22 are the OHP papers. A controller (not shown), which adjusts a printing process to the determination result, controls a fixing temperature of the fixing unit 15. However, this method has the following problems.

First, since a space is secured to load the recording media S, the distance between the light receiving unit 32 and the light emitting unit 31 becomes more distant. Thus, an error may occur when the OHP papers are detected.

Next, the electrostatic printer may include two or more paper feeders, which feed sheets of paper. In this case, since each of the paper feeders has to have an OHP detector, the cost for parts as well as for assembling increases .

### SUMMARY OF THE INVENTION

Accordingly, it is an aspect of the present invention to provide an electrophotographic printer having an improved OHP paper detector capable of being installed close to a recording medium to prevent an error from occurring when detecting OHP papers and detecting the OHP papers without increasing production cost even if a plurality of paper devices are installed.

Additional aspects and advantages of the invention will be set forth in part in the description which follows and, in part, will be obvious from the description, or may be learned by practice of the invention.

The foregoing and/or other aspects of the present invention are achieved by providing an electrophotographic printer including at least one paper feeder, a printing unit, a feed roller, and an overhead projector paper detector. The at least one paper feeder loads recording media. The printing unit that transfers a toner image formed according to an electrophotographic method to the recording media fed from the paper feeder and applies heat and pressure to the recording media so that the toner image is fixed and fused to the recording media. The feed roller is installed between paper feeder and the printing unit and advances the recording media fed from the paper feeder to the printing unit. The overhead projector paper detector is installed between the feed roller and the printing unit to determine whether the recording media are OHP papers.

Here, the recording media are arranged advanced based on one of edges of the width direction of the recording media, and the overhead projector paper detector is installed close to the edge of the recording media.

The overhead projector paper detector includes a light emitting unit and a light receiving unit. The light receiving unit may detect the intensity of light that has been transmitted through the recording media or detect the intensity of light reflected from the recording media.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

The above features and advantages of the present invention will become more apparent by describing in detail exemplary embodiments thereof with reference to the attached drawings in which:

FIG. 1 is a cross sectional view of a conventional electrophotographic printer;

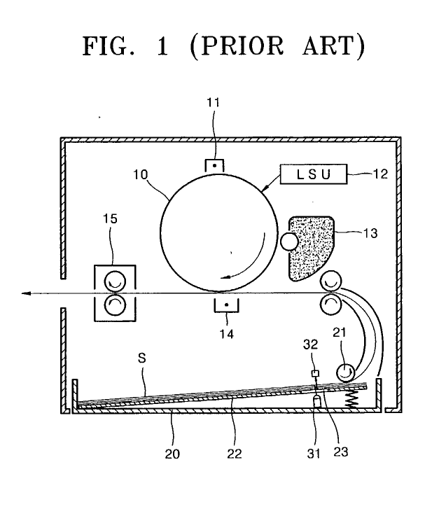

FIG. 2 is a cross-sectional view of a color image printer, which is an example of an electrophotographic printer according to the present invention;

FIG. 3 is a detailed perspective view of portion A shown in FIG. 2;

FIG. 4 is a cross-sectional view of an OHP paper detector, shown in FIG. 2, according to an embodiment of the present invention; and

FIG. 5 is a cross-sectional view of an OHP paper detector, shown in FIG. 2, according to another embodiment of the present invention.

### DESCRIPTION OF THE PREFERRED EMBODIMENTS

Reference will now made in detail to the present preferred embodiment of the present invention, examples of which are illustrated in the accompanying drawings, wherein like reference numerals refer to the like elements throughout. The embodiment is described below in order to explain the present invention by referring to the figures.

Hereinafter the present invention will be described with reference to the attached drawings.

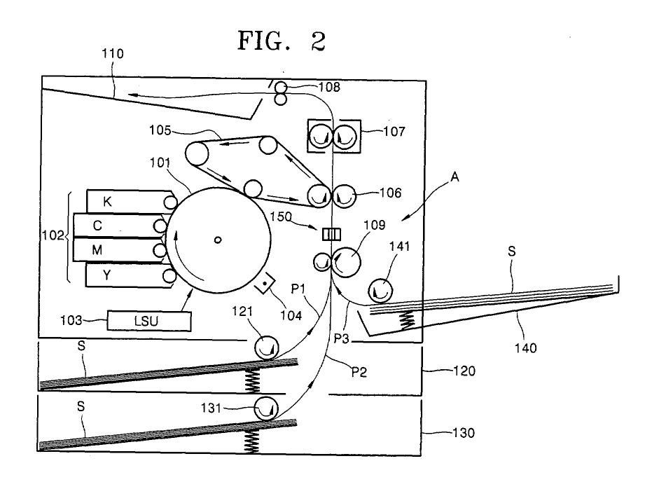

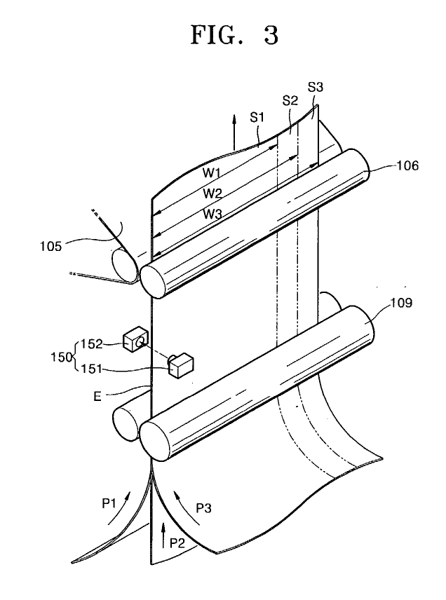

FIG. 2 is a cross-sectional view of a color image printer, which is an example of an electrophotographic printer according to the present invention and FIG. 3 is a detailed perspective view of portion A shown in FIG. 2.

Referring to FIG. 2, a printing unit to form an image according to an electrophotographic method includes a charger 104, an LSU 103, a photoreceptor drum 101, four developer units 102 containing developers each having black K, cyan C, magenta M, and yellow Y colors, a transfer belt 105, a transfer roller 106, and a fixing unit 107.

A process of forming an image using the above-described structure will be described. The charger 104 charges the photoreceptor drum 101 with a uniform surface potential. The LSU 103 scans light corresponding to image information of the yellow color Y onto the photoreceptor drum 101, so that an electrostatic latent image of yellow color Y is formed due to a potential difference between a light-scanned portion and a light-not-scanned portion of the photoreceptor drum 101. The developer unit 102Y supplies the developer of yellow color Y to the electrostatic latent image to form a toner image of yellow color Y. The toner image is transferred to the transfer belt 105.

After the toner image of yellow color is completely transferred to the transfer belt 105, toner images of magenta, cyan, and black colors M, C, and K are sequentially transferred to the transfer belt 105 according to the above-described method so that they overlap on the transfer belt 105. As a result, a multi-color image is formed on the transfer belt 105.

The multi-color image is transferred to a recording medium S passing between the transfer belt 105 and the transfer roller 106, and then heated and pressed by the fixing unit 107 to be fused and fixed to the recording medium S. As a result, a complete multi-color image is obtained and a discharging roller 108 discharges the recording medium S via a discharging tray 110. A method of repeating the four-time transferring process to form a multi-color image is called a multi-pass method.

In the electrophotographic printer, as shown in FIG. 2, the recording media S may be fed by paper feeders of a first cassette 120, a second cassette 130, and a multi-purpose tray 140. The electrophotographic printer may further include third and fourth cassettes (not shown). However, the electrophotographic printer usually includes the first cassette 120 and the multipurpose tray 140 while the second cassette 130 is optional. The first and second cassettes 120 and 130 load standardized papers, such as A4, A3, B4, B5, and the like while the multi-purpose tray 140 loads non-standardized papers.

Hereinafter, a case where the electrophotographic printer includes the first cassette 120, the second cassette 130, and the multi-purpose tray 140 will be described with reference to FIG. 2.

The recording media S loaded in the first cassette 120, the second cassette 130, and the multi-purpose tray 140 are advanced one by one by pickup rollers 121, 131, and 141, respectively, to a feed roller 109 via respective transfer paths P1, P2, and P3. The pickup rollers 121, 131, and 141 only serve to pickup the recording media S and transfer the recording media S to the feed roller 109. The feed roller 109 transfers the recording media S to the printing unit.

By taking this into account, an OHP paper detector 150 is installed between the feed roller 109 and the printing unit. Then, an OHP paper detector does not need to be installed in each of the first cassette 120, the second cassette 130, and the multi-purpose 140. The OHP paper detector 150 installed between the feed roller 109 and the printing unit can detect OHP papers.

In the present embodiment, as shown in FIG. 3, the OHP paper detector 150 is installed between the feed roller 109 and the transfer roller 106. The OHP paper detector 150 includes a light emitting unit 151, which emits light to the recording media S, and a light receiving unit 152, which detects light being transmitted through the recording media S. The light emitting unit 151 and the light receiving unit 152 face each other based on the recording media S. Here, the light emitting unit 151 and the light receiving unit 152 have to be as close as possible within the limit of not affecting the feeding of the recording media S, so that a detection error due to light incident from an external source can be prevented.

The recording media S may be arranged and fed based on the center of the width direction thereof. In this case, it is an aspect of the invention that the OHP paper detector 150 is installed in the center of the width direction of the recording media S. In a case where the recording media S have different widths, a plurality of OHP paper detectors 150 may be installed in consideration of the widths of the recording media S.

In the present embodiment, the recording media S1-S3 are arranged based on an edge E of the width direction thereof when being loaded in the first cassette 120, the second cassette 130, and the multi-purpose tray 140. The recording media S1-S3 are also advanced by the feed roller 109 based on the edge E of the recording media. In other words, as shown in FIG. 3, recording media S1, S2, and S3 each having widths W1, W2, and W3 are arranged and advanced based on the edge E. Thus, in an event that the OHP paper detector 150 is installed on the side of the edge E, although the widths of the recording media S1-S3 are different, the recording media S1-S3 always pass through the OHP paper detector 150. In particular, since the multi-purpose tray 140 uses non-standardized papers as the recording media S, the widths of the recording media S cannot be pre-estimated. Then, a plurality of OHP paper detectors 150 do not need to be installed in the width direction of the recording media S in consideration of different widths of the recording media S.

The light emitting unit 151 may be a photodiode and the light receiving unit 152 may be one of various types of light receiving devices, such as a phototransistor, a photodiode, or the like. However, the light emitting unit 151 is not limited thereto, but may be of any type of light emitting unit that will perform the intended results. The light receiving unit 152 detects the intensity of light being transmitted through the recording media S and transmits the detected result to a controller (not shown), which controls the printing process. Since OHP papers are transparent papers, the OHP papers mostly transmit light. However, since plain papers are not transparent, these papers transmit a smaller amount of light than the OHP papers do. Thus, the controller (not shown) sets a proper reference value, and then determines that the OHP papers are advanced if the detected light intensity is greater than the reference value while in the opposite case, determines that the plain papers are advanced. Since a printer generally uses plain papers as the recording media S, the temperature of the fixing unit 107 is set to thermal characteristics of the plain papers. Thus, if it is determined that the OHP papers are advanced, the temperature of the fixing unit 107 is adjusted to the thermal characteristics of the OHP papers. In this case, the temperature of the fixing unit 107 is decreased to a temperature lower than when the plain papers are advanced.

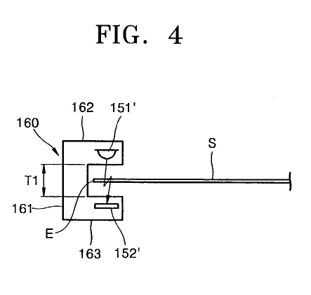

FIG. 4 is a cross-sectional view of an OHP paper detector, shown in FIG. 2, according to another embodiment of the present invention. Referring to FIG. 4, the OHP paper detector includes a light emitting unit 151′ and a light receiving unit 152′, which are assembled with a frame 160. The frame 160 includes a vertical part 161, which is close to the edge E of the recording media S, and first and second horizontal parts 162 and 163, which extend up and down the recording media S. The light emitting unit 151′ is assembled with the first horizontal part 162 and the light receiving unit 152′ is assembled with the second horizontal part 163. However, the opposite case can be provided as an alternative. It is preferable that the frame 160 is installed so that the vertical part 161 is slightly apart from the edge E of the recording media S. In this structure, since the light emitting unit 151′ and the light receiving unit 152′ may form a single body, it is easy to handle each of the parts. Also, since a distance T1 between the light emitting unit 151′ and the light receiving unit 152′ is constant, it is possible to stably detect OHP papers.

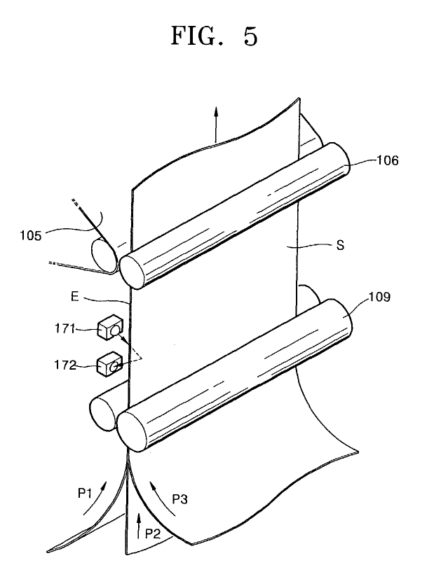

FIG. 5 is a perspective view of an OHP paper detector, shown in FIG. 2, according to another embodiment of the present invention.

Whether OHP papers are being advanced can be determined by measuring the intensity of light reflected from the recording media S. Referring to FIG. 5, a light emitting unit 171 is installed between a feed roller 109 and a transfer roller 106. A light receiving unit 172, which detects the intensity of light emitted from the light emitting unit 171 and reflected from the recording media S, is installed near to the light emitting unit 171. It is as aspect of the invention that the light emitting unit 171 and the light receiving unit 172 are installed on the side of the edge E. Since plain papers are mostly white, the plain papers reflect light. Since OHP papers are transparent papers, the OHP papers mostly transmit light. Thus, if the intensity of light detected by the light receiving unit 172 is greater than a predetermined reference value, a controller (not shown) determines that the plain papers are advanced, while if the intensity of light detected by the light receiving unit 172 is less than the predetermined reference value, the controller determines that the OHP papers are advanced. Here, it is an aspect that a guide surface (not shown) is painted with black on the opposite side of the light emitting unit 171 and the light receiving unit 172. The guide surface guides the recording media S so that the OHP papers are not misconceived as the plain papers when detecting from the light receiving unit 172 light that has been transmitted through the OHP papers and then has been reflected. The light emitting unit 171 and the light receiving unit 172 may form a single unit.

It is an aspect of the invention that the above-described OHP paper detector is installed close to the feed roller 109 because if it is determined that OHP papers are advanced, the time required for adjusting the temperature of the fixing unit 107 to thermal characteristics of the OHP papers needs to be secured before the OHP papers reach the fixing unit 107.

In the above-described embodiment, it has been described that an electrophotographic color printer using a multi-pass method uses an OHP paper detector. However, the invention is not limited thereto. In other words, the OHP paper detector can be used in single color or multi-color electrophotographic printers having various types of structures.

As described above, in an electrophotographic printer according to the embodiments of the present invention, an OHP paper detector is installed between a feed roller, which feeds recording media to a printing unit, and the printing unit. Thus, even though the recording media are fed from a plurality of paper feeders, only one OHP paper detector can detect the OHP papers.

Also, the recording media is arranged and advanced based on the edge of the recording media and the OHP paper detector is installed on the side of the edge. Thus, although recording media having different widths are used, only one OHP paper detector is necessary to detect the OHP papers.

Furthermore, in a case where an OHP paper detector is constituted as an assembling body, it is easy to handle parts and the distance between a light emitting unit and a light receiving unit is constant. Thus, it is possible to stably detect the OHP papers.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrophotographic printer comprising:
at least one paper feeder that loads recording media;
a printing unit that transfers a toner image formed according to an electrophotographic method to the recording media fed from the paper feeder and applies heat and pressure to the recording media so that the toner image is fixed and fused to the recording media;
a feed roller installed between paper feeder and the printing unit and advances the recording media fed from the paper feeder to the printing unit; and
an overhead projector paper (OHP) detector installed between the feed roller and the printing unit to determine whether the recording media are OHP papers.

2. The electrophotographic printer of claim 1, wherein the recording media are advanced based on one of edges of a width direction of the recording media, and the overhead projector paper detector is installed close to the edge of the recording media.

3. The electrophotographic printer of claim 2, wherein the overhead projector paper detector comprises:
a light emitting unit that emits light to the recording media; and
a light receiving unit that faces the light emitting unit based on the recording media and detects the intensity of light that has been transmitted through the recording media.

4. The electrophotographic printer of claim 3, wherein the overhead projector paper detector further comprises a frame that includes a vertical part and two horizontal parts, which extend up and down the recording media and in which the light emitting unit and the light receiving unit are installed, wherein the frame is installed so that the vertical part is spaced apart from the edge of the recording media.

5. The electrophotographic printer of claim 2, wherein the overhead projector paper detector comprises:
a light emitting unit that emits light to the recording media; and
a light receiving unit that detects the intensity of light reflected from the recording media.

6. The electrophotographic printer of claim 1, wherein the overhead projector paper (OHP) detector is positioned close to the feed roller.

7. An electrophotographic printer comprising:
a printing unit to transfer an image onto a recording medium;
a fixing unit to fix the transferred image;
plural paper feeders each to load recording media to the printing unit to have the image to be transferred thereon; and
a single paper detector to detect whether the recording media loaded by any of the plural paper feeders are overhead projector papers or a general recording paper.

8. The electrophotographic printer of claim 7, wherein the single paper detector comprises:
a light emitting unit to emit light onto the recording media being loaded; and
a light detecting unit to detect the light emitted onto the recording media.

9. The electrophotographic printer of claim 7, wherein the single paper detector is positioned at an edge of the width of the recording media being loaded.

10. The electrophotographic printer of claim 9, wherein the light emitting unit and the light detecting unit are positioned on opposite sides of the recording media being loaded.

11. The electrophotographic printer of claim 9, wherein the light emitting unit and the light detecting unit are positioned on the same side of the recording media being loaded.

12. The electrophotographic printer of claim 8, further comprising a controller to control the temperature of the fixing unit depending on whether the recording media being loaded is an overhead projector paper or general recording paper.

13. An electrophotographic printer comprising:
a printing unit to transfer an image onto a recording medium;
a fixing unit to fix the transferred image;
a paper feeder to load recording media to the printing unit to have the image to be transferred thereon;
a feed roller to feed the paper from the paper feeder to the printing unit; and
a paper detector to detect whether the recording media are overhead projector papers or a general recording paper, the paper detector being positioned close to the feel roller to provide time to adjust the temperature of the fixing unit depending on the type of recording media loaded.
